(19) United States
(12) Patent Application Publication
(10) Pub. No.: US 2019/0076760 A1
(43) Pub. Date: Mar. 14, 2019

(54) FILTER ASSEMBLY WITH INTEGRATED WIRELESS FILTER INDICATOR AND AUTOMATED FILTER ELEMENT COMPLIANCE AND SERVICE MONITORING

(71) Applicant: Schroeder Industries, LLC, Leetsdale, PA (US)

(72) Inventors: Scott Surdick, Dormont, PA (US); Chris Bortnik, Warrendale, PA (US); Chris Presnar, New Castle, PA (US); Kelly Appleton, Penfield, NY (US); Scott Mutschler, Aliquippa, PA (US)

(21) Appl. No.: 16/179,115

(22) Filed: Nov. 2, 2018

Related U.S. Application Data
(63) Continuation of application No. PCT/US2017/030851, filed on May 3, 2017.
(60) Provisional application No. 62/331,943, filed on May 4, 2016.

(51) Int. Cl. B01D 35/143; B01D 35/147; B01D 29/21

(52) U.S. Cl. CPC B01D 35/143; B01D 2201/56; B01D 29/21; B01D 35/147

(57) ABSTRACT

A filter assembly with integrated wireless filter indicator includes a housing within a line of intended fluid flow; a replaceable filter element within the housing; a bypass valve within the housing which operates to allow fluid to selectively bypass the filter element; a filter indicator for base indicator functions including the indication of filter element status, the filter indicator including a wireless transmitter; a downloadable software application configured to be downloaded on user devices and configured to allow the filter indicator to communicate with the user devices regarding filter condition; and a wireless identification tag coupled to the replaceable filter element to identify the filter element and configured to be in communication with at least one of i) the wireless transmitter of the filter indicator or ii) the software application on at least one of the user's devices.

### RELATED APPLICATIONS

This application is a continuation of international patent application serial number PCT/US2017/030851, which designated the United States, filed May 3, 2017 and published Nov. 9, 2017 as publication number WO 2017/192729, which publication is incorporated herein by reference. International patent application serial number PCT/US2017/030851 claims priority to U.S. Patent Application Ser. No. 62/331,943 filed May 4, 2016, entitled “Filter Assembly with Integrated Wireless Filter Indicator and Automated Filter Element Compliance and Service Monitoring” which application is incorporated herein by reference in its entirety.

### BACKGROUND INFORMATION

### 1. Field of the Invention

The present invention relates to filter indicators for filter assemblies and more particularly to integrated wireless filter indicators having automated filter element compliance and service monitoring.

### 2. Background Information

Filter assemblies for hydraulic fluid, lubricating fluid, fuels and the like are well known and form the essential product line of the applicant, Schroeder Industries. For the purposes of this application the main elements of a conventional filter assembly includes a filter housing, an inlet of fluid to be filtered into the housing, a filter element within the housing within line of intended fluid flow and an outlet of, presumably, filtered fluid extending from the housing. Additionally the filter assembly will conventionally include a bypass valve which operates as a safety mechanism or as an overpressure relief valve to allow fluid to bypass the filter element if its flow restriction is excessive (noted by an increase in pressure), such as to protect the remaining elements of the system from fluid starvation. Filter bypass may occur if the filter is clogged or the fluid is thickened by cold weather. The bypass valve may be incorporated into the filter element or a separate part of the filter assembly.

As applications for filter assemblies become more sophisticated and widespread, the need for highly sensitive diagnostic equipment to measure and analyze the performance of hydraulic filter systems is increasing. Today's filter systems have seen a shift from reactionary to preventative maintenance.

The applicant, Schroeder Industries, takes great pride in the filtration assembles it produces; however, these products are useless if they go into bypass and no longer filter the fluid. Schroeder Industries Dirt Alarm® filter indicators provide accurate indicator of when the filter element needs to be changed to prevent the filter housing from bypassing the filter element. Schroeder industries has developed filter indicators for pressure applications, return line applications as well as suction applications so that all of our filtration assemblies can be provided with accurate Filter indicators. These known indicators come in a variety so types and styles. Schroeder Industries uses visual indicators (pop-up or gauge) indicators to show a visible difference in the filter housing. Schroeder Industries also has electrical indicators that can be wired to a PLC, or light display on a control panel to indicate when the filter housing needs to be serviced.

As with all of Schroeder Industries product lines, the known indicators have been customized to meet the needs of a customer's specific application. The trip setting of these indicators is typically 2-3 psi less than the bypass setting of the filter assembly's bypass valve, but in certain applications the customer may have required a lower trip setting.

It is axiomatic that the fluid is only clean if it is being filtered. A filter assembly that is consistently run in bypass mode, whether it is due to a clogged element or cold start conditions, will not keep the fluid clean. Using Schroeder Industries Dirt Alarm® filter indicators with the filter assemblies has helped improve the amount of fluid which is filtered and allowed the associated machine or system to which the filter assembly is coupled to run cleaner.

Existing filter indicators, however, do not address routine maintenance associated with filter assemblies related to replaceable filter elements nor do the existing indicators address the problem of when a non-complying filter element is installed with a filter assembly. Further the effectiveness of real time notification can be improved with the existing filter indicators.

Parent application international patent application serial number PCT/US2017/030851 published Nov. 9, 2017 as publication number WO 2017/192729, which publication is incorporated herein by reference. The associated international search report identified WO 2013/106185, WO 2016/022923, RU 2202398 and SU 671056 as documents defining the general state of the art relative to the present invention.

Thus there remains a need for an inexpensive, efficient and effective filter indicators that address these deficiencies of the prior art systems.

### SUMMARY OF THE INVENTION

The present invention provides a filter assembly with integrated wireless filter indicator and automated filter element compliance and service monitoring and method of using the same.

One aspect of the present invention provides A filter assembly with integrated wireless filter indicator includes a housing within a line of intended fluid flow; a replaceable filter element within the housing; a bypass valve within the housing which operates to allow fluid to selectively bypass the filter element; a filter indicator for base indicator functions including the indication of filter element status, the filter indicator including a wireless transmitter; a downloadable software application configured to be downloaded on user devices and configured to allow the filter indicator to communicate with the user devices regarding filter condition; and a wireless identification tag coupled to the replaceable filter element to identify the filter element and configured to be in communication with at least one of i) the wireless transmitter of the filter indicator or ii) the software application on at least one of the user's devices.

The filter assembly with integrated wireless filter indicator according to one aspect of the invention provides that the filter assembly with integrated wireless filter indicator is configured to provide automated filter element compliance. The filter assembly with integrated wireless filter indicator according to one aspect of the invention provides that the filter assembly with integrated wireless filter indicator is configured to provide automated service monitoring.

The filter assembly with integrated wireless filter indicator according to one aspect of the invention provides that the filter indicator wireless transmitter is a serialized BLUETOOTH transmitter and wherein each user device is BLUETOOTH enabled device, and wherein the downloadable software application is configured to show on the user device when the indicator has tripped.

The filter assembly with integrated wireless filter indicator according to one aspect of the invention provides that the indicator is one of an electrical indicator, an electrical indicator and visual indicator, an electrical indicator with thermal lockout feature, or an electrical indicator and visual indicator with thermal lockout feature.

The filter assembly with integrated wireless filter indicator according to one aspect of the invention provides that wireless identification tag coupled to the replaceable filter element is one of a NFC tag or an RFID tag. The filter assembly with integrated wireless filter indicator according to one aspect of the invention further includes a tag reader associated with the integrated wireless filter indicator wherein the wireless identification tag coupled to the replaceable filter element to identify the filter element is configured to be in communication with at least the wireless transmitter of the filter indicator via the identification tag being paired with the tag reader. The filter assembly with integrated wireless filter indicator according to one aspect of the invention provides that the wireless identification tag coupled to the replaceable filter element to identify the filter element is configured to be in communication with at least the software application on at least one of the user's devices whereby the identification tag is paired with a tag reader on the user's device in which the app is installed. The filter assembly with integrated wireless filter indicator according to one aspect of the invention provides that the wireless identification tag coupled to the replaceable filter element must be scanned with a device of the user in order to validate the software application.

The filter assembly with integrated wireless filter indicator according to one aspect of the invention provides that the software application is configured to forward information to third party filter assembly support personnel. The filter assembly with integrated wireless filter indicator according to one aspect of the invention provides that third party filter assembly support personnel includes at least one of manufacturers, regional service managers and original equipment manufacturers. The filter assembly with integrated wireless filter indicator according to one aspect of the invention provides that the software application is configured to receive information from third party filter assembly support personnel.

The filter assembly with integrated wireless filter indicator according to one aspect of the invention provides that the software application is configured to prompt the user to enter a service interval for the element. The filter assembly with integrated wireless filter indicator according to one aspect of the invention provides that the software application is configured to provide the user with service alerts after the filter element has been in use a predetermined time and wherein the service alerts will continue periodically until the element has been changed.

These and other aspects of the present invention will be clarified in the description of the preferred embodiment of the present invention described below in connection with the attached figures in which like reference numerals represent like elements throughout.

### BRIEF DESCRIPTION OF THE DRAWINGS

FIG. 1 is a schematic elevation sectional view of a filter assembly with integrated wireless filter indicator and automated filter element compliance and service monitoring according to one embodiment of the present invention;

FIG. 2 is a perspective view of a filter element for use with the filter assembly of FIG. 1; and

FIG. 3 is a schematic view of the filter assembly of FIG. 1 illustrating automated filter element compliance and service monitoring according to one embodiment of the present invention.

### BRIEF DESCRIPTION OF THE PREFERRED EMBODIMENTS

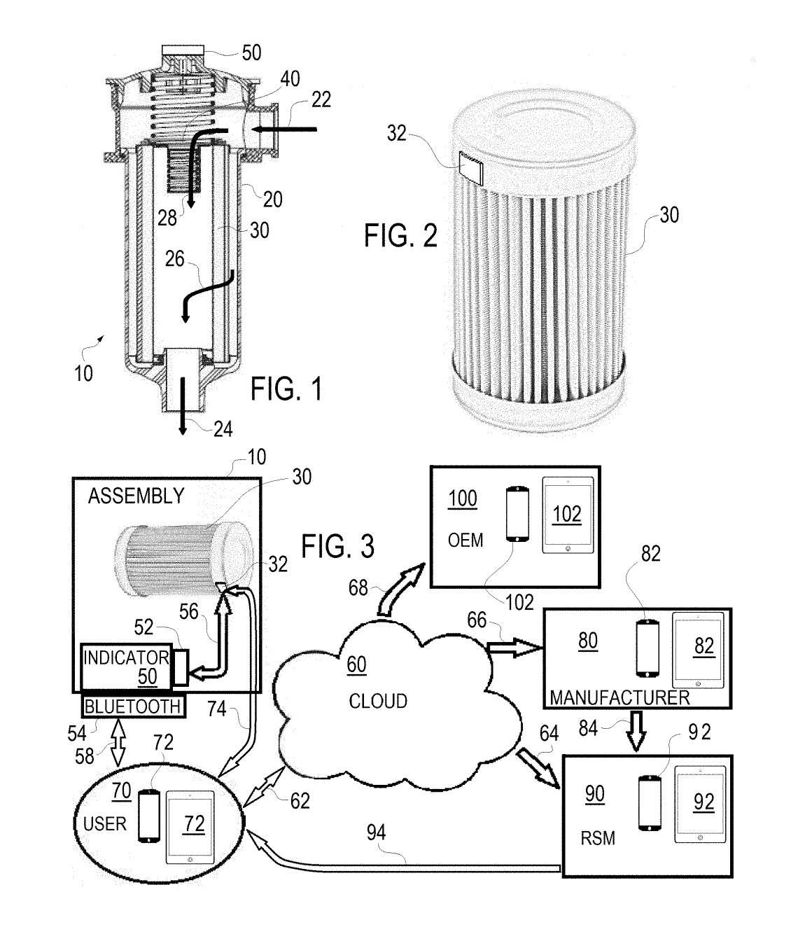

As shown in FIGS. 1-3 a filter assembly 10 according to the present invention is provided with an integrated wireless filter indicator 50 and provides automated filter element 30 compliance and service monitoring. The conventional elements of the filter assembly 10 includes a filter housing 20, an inlet 22 of fluid to be filtered into the housing 20, a replaceable filter element 30 (conventional except for tag 32) within the housing 20 within a line of intended fluid flow 26 and an outlet 24 of, preferably, filtered fluid extending from the housing 20. Additionally, conventional elements of the filter assembly 10 include a bypass valve 40 which operates as a safety mechanism or as an overpressure relief valve to allow fluid to bypass the filter element 30 along path 28 if the flow restriction through the element 30 is excessive. The filter assembly 10 is not limited to the outside in flow shown in FIG. 1 or the inlet in the top and outlet in the bottom and can take many known configurations. The construction of the housing 20, filter element 30 and bypass valves 40 are generally known in the art.

The construction and operation of the filter indicator 50, outside of the reader 52 and Bluetooth transmitter 54, is also known in the art and are referenced as basic indicator functions. The filter indicator 50 may operate as one of the Dirt Alarm® indicators from Schroeder for base indicator functions namely the indication of filter element status. For example the filter indicator 50 may be a visual indicator that provides an economical way to know at a glance when the associated filter element 30 needs to be replaced. A variety of styles of visual indicators are available, ranging from gauges to mechanical pointers and pop-up cartridges. The pop-up indicator is interchangeable with other cartridge style indicators (electrical and electrical visual) available from Schroeder.

The indicator 50 may include a thermal lockout feature. The thermal lockout feature prevents activation of the indicator 50 below a set temperature, e.g., temperatures below 90° F. (32° C.). This feature is helpful in mobile applications where fluid temperatures may be well below 90° F. at equipment start-up, and this feature will prevent the indicator 50 from showing a premature need to change the element 30.

The indicator 50 will be an electrical indicator in that the indicator 50 utilizes an electric signal in implementation of the alarm. In addition to the Bluetooth operation discussed below, the electrical signal may activate various electric alarms on the filter assembly or for complete machine shutdown.

Thus the indicator 50 may be an electrical indicator, or an electrical indicator and visual indicator, or an electrical indicator with thermal lockout feature, or an electrical indicator and visual indicator with thermal lockout feature.

The filter indicator 50 according to the present invention includes an integral Bluetooth transmitter 54. The signal 58 can be received by a Bluetooth enabled device such as smart phone or computer (72 or 82, or 92 or 102). When the indicator 50 trips, a signal 58 is sent to the linked software (see below). Each Bluetooth indicator 50 will be serialized, in other words unique and identifiable. In parallel, appropriate filter elements 30 will be packaged with a coded NFC tag 32.

As background, Bluetooth technology is a global wireless communication standard that connects devices together over a certain distance. Bluetooth technology is built into billions of products on the market today and connects the Internet of Things (IoT). A Bluetooth device uses radio waves instead of wires or cables to connect to a bluetooth enabled device such as a smartphone or computer (72, 82, 92, or 102).

When two Bluetooth devices want to talk to each other, they need to pair. Communication between Bluetooth devices happens over short-range, ad hoc networks known as piconets. A piconet is a network of devices connected using Bluetooth technology. The network generally ranges from two to eight connected devices. When a network is established, one device takes the role of the master while all the other devices act as slaves. Piconets are established dynamically and automatically as Bluetooth devices enter and leave radio proximity. Current Bluetooth technology, with the advent of Bluetooth Smart (BLE or Bluetooth low energy), is low power and can run off tiny coin-cell batteries for months, and in some cases, years.

In the present invention, when a user 70 obtains an assembly 10 with an indicator 50 with Bluetooth technology 54 (or when the user 70 purchases a Bluetooth indicator 50 for use with an existing assembly 10), a free app will be offered to the user 70 to download onto a Bluetooth device 72 (e.g., a smartphone or tablet) from the cloud 60 via coupling 62. The user 70 enters the serial number of the indicator 50 in order to activate or to download the app. In addition to the serial number of the indicator 50, the user 70 will be prompted to enter other basic mandatory information such as contact name, mobile phone number, email address, address, etc.

The app of the invention will allow the user 70 to see when the indicator 50 has tripped on a smart phone, tablet, etc. It is presumed that this real time system notification on a device 72 generally on the user 70 will be faster and more effective than the remaining conventional assembly bound alarms activated by the indicator 50. The app is designed for standard operating systems, such as iPhone, Android, Windows. As noted above, technically the Bluetooth transmitter 54 is coupled to the Bluetooth enabled device 72 when they are paired, such that coupling 58 in FIG. 3 is technically directly with the device 72 of the user 70 and via the application to the cloud 60 via coupling 62, however as a concept the system of the invention is better understood as shown in FIGS. 3.

The system of the present invention also provides for automated filter element compliance, meaning that the system will assure that the proper filter element 30 is present and in place with the assembly 10. It is possible that the user 70 (or a service provider such as a regional service manager or RSM 90) removes a clogged filter element 30 and forgets to replace the filter element 30, or installs a wrong filter element 30 (i.e. one having different operating parameters). The system of the invention provides two methods for filter element compliance, each utilizing the identification tag 32, namely an NFC tag, coupled to the filter element 30. The tag 32 may also be an RFID tag but, as noted below, due to the available readers the NFC tag is preferred.

NFC stands for Near Field Communication which is a set of communication protocols that enable two electronic devices, one of which is usually a portable device such as a smartphone, to establish communication by bringing them within 4 cm (2 in) of each other. NFC is a lot like RFID, only it's a more up-close-and-personal type of wireless. Whereas RFID can be used from a distance, NFC readers work at a maximum range of about 4 inches (10 centimeters). Unlike RFID versions, NFC readers aren't always specialized devices and NFC reader chips are available in many current commercial smartphone circuitry.

The system of the invention provides one method for filter element compliance utilizing the identification tag 32 paired with a tag reader 52 on the indicator 50. If RFID tag for tag 32 is used then this implementation for filter element compliance is preferred, because the reader 52 is assured of compatibility with the tag 32.

The system of the invention provides a second, complementary, method for filter element compliance utilizing the identification tag 32 paired with a tag reader on the user's device 72 in which the app is installed. The NFC tag 32 must be scanned with a smartphone 72 in order to validate the app. The app will be designed so that it functions only when an acceptable or proper filter element 50 is installed. As opposed to simply not working, the app, alternatively, may identify to the user 70 when the indicator 50 and/or the device 72 indicates that a proper filter element 30 is not in place.

In addition to wireless indication of alarm conditions via the Bluetooth enabled indicator 50 and the filter compliance monitoring due to the tag 32, the present system facilitates servicing of the assembly 10. Upon implementation of the app the user 70 is prompted by the app to enter a service interval for the element; for example, 3 months, 6 months, 1 year, etc. Thus, when the indicator 50 is tripped, due to the pressure/differential pressure threshold being reached, an alert appears on the user's Bluetooth enabled device 72. Optionally, an email or text messages can be sent to designated recipients, such as maintenance people and their managers, buyers, etc. as designated by the user during set up. In addition, an alert/email/text message will be sent to the user's device 72 (or other designated device) when the service interval is reached. Regardless of what service interval is entered, alerts may be sent after the filter element 30 has been in use a manufactures designated time, namely 1 year. The service alerts will continue weekly, until the element 30 has been changed, and new element information is entered into the app/software, namely a new tag 32 associated with the new element 30 is scanned.

The server based software (cloud) records the locations of the universe of filter elements 30 or assemblies 10 that need serviced, as well as other important contact information. The software can forward reports to third party filter assembly support personnel, such as manufacturers 80, regional service managers 90 and original equipment manufacturers 100, and some of these parties may play multiple and/or overlapping roles. Periodic reports and/or alerts via coupling 66 can be programmed for manufacturer 80 recipients to appear on their devices 82 as desired. The manufacturers 80 can contact the appropriate regional service managers 92 to suggest prospective service and can include shipment of the appropriate elements 30 at step 84, greatly increasing service time (as opposed to the user 70 ordering elements from the RSM 90 who in turn places an order from the manufacturer 80) Periodically, e.g., once a month, a report may be sent to the regional service managers (RSM) 90, showing which of their customers (users 90) have elements 30 that need to be replaced. The regional service managers can contact the appropriate users 70 to suggest prospective service and can include shipment of the appropriate elements 30 at step 94, again greatly increasing service time and customer satisfaction.

Additionally, the system of the invention has value for large OEMs as an automated mechanisms to guarantee Warranty protection. End users 70 must register equipment associated with the assembly 10, and assembly 10 of the invention will automatically validate the proper use of a proper element 30 via tag 32 as noted above. This will assure that a high quality element 30 is in place to protect expensive hydraulic components and that the assembly has not been operated excessively in bypass mode. If a proper element 30 is not used, the system will note this and the OEM is not liable for warranty claims.

A description of the logic is shown below.

Sequence 1—Setup
Register end user 70 and devices 72
Setup and pair the indicator(s) 50 with the app on devices 72 and the registered end user

Database includes end user ID and Indicator ID

Sequence 2—Pairing
Pair the indicator 50 with the id of element NFC tag 32

Database includes the Customer ID, Indicator ID, NFC tag ID and timestamp
Pairing also checks the validity of the NFC tag 32
   valid=unique Customer ID, Indicator ID, NFC tag ID combination

Sequence 3—Operation
Indicator 50 setting is reached and the app notifies the end user
Once the indicator 50 has a logic of 1 for X period of time, the indicator 50 and element 30 are de-paired. The system can maintain a log of all events for each assembly 10 and element 30.

It is apparent that many variations to the present invention may be made without departing from the spirit and scope of the invention. The present invention is defined by the appended claims and equivalents thereto.

What is claimed is:

1. A filter assembly with integrated wireless filter indicator comprising:
a housing within a line of intended fluid flow;
a replaceable filter element within the housing;
a bypass valve within the housing which operates to allow fluid to selectively bypass the filter element;
a filter indicator for base indicator functions including the indication of filter element status, the filter indicator including a wireless transmitter;
a downloadable software application configured to be downloaded on user devices and configured to allow the filter indicator to communicate with the user devices regarding filter condition; and
a wireless identification tag coupled to the replaceable filter element to identify the filter element and configured to be in communication with at least one of i) the wireless transmitter of the filter indicator or ii) the software application on at least one of the user's devices.

2. The filter assembly with integrated wireless filter indicator according to claim 1 wherein the filter assembly with integrated wireless filter indicator is configured to provide automated filter element compliance.

3. The filter assembly with integrated wireless filter indicator according to claim 1 wherein the filter assembly with integrated wireless filter indicator is configured to provide automated service monitoring.

4. The filter assembly with integrated wireless filter indicator according to claim 1 wherein the filter indicator wireless transmitter is a serialized BLUETOOTH transmitter and wherein each user device is BLUETOOTH enabled device.

5. The filter assembly with integrated wireless filter indicator according to claim 4 wherein the downloadable software application is configured to show on the user device when the indicator has tripped.

6. The filter assembly with integrated wireless filter indicator according to claim 1 wherein the indicator is one of an electrical indicator, an electrical indicator and visual indicator, an electrical indicator with thermal lockout feature, or an electrical indicator and visual indicator with thermal lockout feature.

7. The filter assembly with integrated wireless filter indicator according to claim 1 wherein wireless identification tag coupled to the replaceable filter element is one of a NFC tag or an RFID tag.

8. The filter assembly with integrated wireless filter indicator according to claim 1 further including a tag reader associated with the integrated wireless filter indicator wherein the wireless identification tag coupled to the replaceable filter element to identify the filter element is configured to be in communication with at least the wireless transmitter of the filter indicator via the identification tag being paired with the tag reader.

9. The filter assembly with integrated wireless filter indicator according to claim 1 wherein the wireless identification tag coupled to the replaceable filter element to identify the filter element is configured to be in communication with at least the software application on at least one of the user's devices whereby the identification tag is paired with a tag reader on the user's device in which the app is installed.

10. The filter assembly with integrated wireless filter indicator according to claim 1 wherein the wireless identification tag coupled to the replaceable filter element must be scanned with a device of the user in order to validate the software application.

11. The filter assembly with integrated wireless filter indicator according to claim 1 wherein the software application is configured to forward information to third party filter assembly support personnel.

12. The filter assembly with integrated wireless filter indicator according to claim 11 wherein third party filter assembly support personnel includes at least one of manufacturers, regional service managers and original equipment manufacturers.

13. The filter assembly with integrated wireless filter indicator according to claim 11 wherein the software application is configured to receive information from third party filter assembly support personnel.

14. The filter assembly with integrated wireless filter indicator according to claim 1 wherein the software application is configured to prompt the user to enter a service interval for the element.

15. The filter assembly with integrated wireless filter indicator according to claim 1 wherein the software application is configured to provide the user with service alerts after the filter element has been in use a predetermined time and wherein the service alerts will continue periodically until the element has been changed.

16. A filter assembly with integrated wireless filter indicator comprising:
a housing within a line of intended fluid flow;
a replaceable filter element within the housing;
a filter indicator for base indicator functions including the indication of filter element status, the filter indicator including a wireless transmitter, wherein the filter indicator is configured to provide automated filter element compliance and to provide automated service monitoring;
a downloadable software application configured to be downloaded on user devices and configured to allow the filter indicator to communicate with the user devices regarding filter condition including automated filter element compliance and automated service monitoring; and
a wireless identification tag coupled to the replaceable filter element to identify the filter element and configured to be in communication with at least one of i) the wireless transmitter of the filter indicator or ii) the software application on at least one of the user's devices, wherein the filter indicator wireless transmitter is a serialized BLUETOOTH transmitter and wherein each user device is BLUETOOTH enabled device.

17. The filter assembly with integrated wireless filter indicator according to claim 16 wherein wireless identification tag coupled to the replaceable filter element is one of a NFC tag or an RFID tag.

18. The filter assembly with integrated wireless filter indicator according to claim 16 further including a tag reader associated with the integrated wireless filter indicator wherein the wireless identification tag coupled to the replaceable filter element to identify the filter element is configured to be in communication with at least the wireless transmitter of the filter indicator via the identification tag being paired with the tag reader.

19. The filter assembly with integrated wireless filter indicator according to claim 16 wherein the wireless identification tag coupled to the replaceable filter element to identify the filter element is configured to be in communication with at least the software application on at least one of the user's devices whereby the identification tag is paired with a tag reader on the user's device in which the app is installed.

20. The filter assembly with integrated wireless filter indicator according to claim 16 wherein the wireless identification tag coupled to the replaceable filter element must be scanned with a device of the user in order to validate the software application.
